(19) United States
(12) Patent Application Publication
(10) Pub. No.: US 2012/0020762 A1
(43) Pub. Date: Jan. 26, 2012

(54) LOAD LIFTING TRAILER

(76) Inventor: GERALD L. ROOSE, Pella, IA (US)

(21) Appl. No.: 12/843,171

(22) Filed: Jul. 26, 2010

(51) Int. Cl. B60P 1/02

(52) U.S. Cl. 414/495; 280/6.151

(57) ABSTRACT

The invention relates to a load lifting trailer including a frame and a bed operatively attached to the frame for actuated movement between trailing and loading positions. A pivot plate having first, second and third connectors pivotally attach the frame to the bed and to each other, and when actuated by a linear extensible actuator provides the necessary force for moving the bed relative to the frame of the trailer up and down between trailing and loading positions.

### BACKGROUND OF THE INVENTION

1. Field of the Invention

This invention relates generally to a load lifting trailing having a bed moveable between trailing and loading positions relative to the frame.

2. Description of Prior Art

U.S. Pat. No. 6,273,435 shows a trailer with a non-tilting moveable bed. This trailer includes a hydraulic cylinder which is connected to a linkage between a base and bed frame. Extension of the hydraulic cylinder causes the linkage to articulate and causes movement of the bed frame relative to the base frame. The bed frame is guided in a series of tracks between an elevated position and a lowered position.

The device of U.S. Pat. No. 6,273,435 has the disadvantage of requiring a complicated mechanical linkage between a hydraulic cylinder bed frame and the base frame. Furthermore, the hydraulic cylinder rises and powers in unison with the bed frame, rather than being stationary relative to the base frame.

Therefore a primary object of the present invention is to provide a load lifting trailer having a bed moveable between trailing and loading positions relative to the base frame.

A further objective of the present invention is to provide a load lifting trailer that is suitable for use with a towing vehicle.

A further objective of the present invention is to provide a load lifting trailer which can be moved between trailing and loading positions without tilting the bed for easy loading and unloading of machinery or other objects being transported.

A still further objective of the present invention is to provide a load lifting trailer having a new, safe design.

A still further objective of the present invention is to provide a load lifting trailer which uses a simple mechanism for moving the bed between trailing and loading positions.

A still further objective of the present invention is to provide a load lifting trailer which is easy to use and economical to manufacture.

The means and method of accomplishing these and other objectives will become apparent in the following description of the invention.

### BRIEF SUMMARY OF THE INVENTION

In one embodiment, the invention is a trailer having a frame with a pair of longitudinally extending frame members and a bed operatively attached to the pair of longitudinally extending frame members. The bed is actuated between trailing and loading positions by a pivot plate pivotally attached to a longitudinally extending frame member and to the bed and by means imparting rotation to the pivot plate for moving the bed between trailing and loading positions.

In another embodiment, the invention is a method for raising and lowering the bed of a trailer between trailing and loading positions. The method includes the steps of providing a trailer having a frame with a pair of longitudinally extending frame members and a bed operably attached to the pair of longitudinally extending frame members. The bed is actuated between trailing and loading positions by connecting a pivot plate to a longitudinally extending frame member, the bed and means for imparting rotation to the pivot plate, and rotating the pivot plate about a fixed pivot point on the longitudinally frame member for moving the bed up and down.

### BRIEF DESCRIPTION OF THE DRAWINGS

While the specification concludes with the claims particularly pointing out and distinctly claiming the invention, it is believed that the present invention will be better understood from the following description taken in conjunction with the accompanying drawings, in which:

FIG. 1 is a perspective view of the present invention with the bed in a loading position;

FIG. 2 is a perspective view of the present invention with the bed in a trailing position;

FIG. 3 is a rear elevation view of the present invention with the bed in a loading position;

FIG. 4 is a side elevation view of the bed lifting and lowering assembly with the bed in a loading position and wheels not shown for purposes of illustration;

FIG. 5 is a side elevation view of the bed lifting and lowering assembly with the bed in a trailing position and wheels not shown for purposes of illustration;

FIG. 6A is an enlarged view of the bed lifting and lowering assembly taken along line 6A-6A in FIG. 2.

FIG. 6B is an enlarged view of the bed lifting and lowering assembly taken along line 6B-6B in FIG. 2.

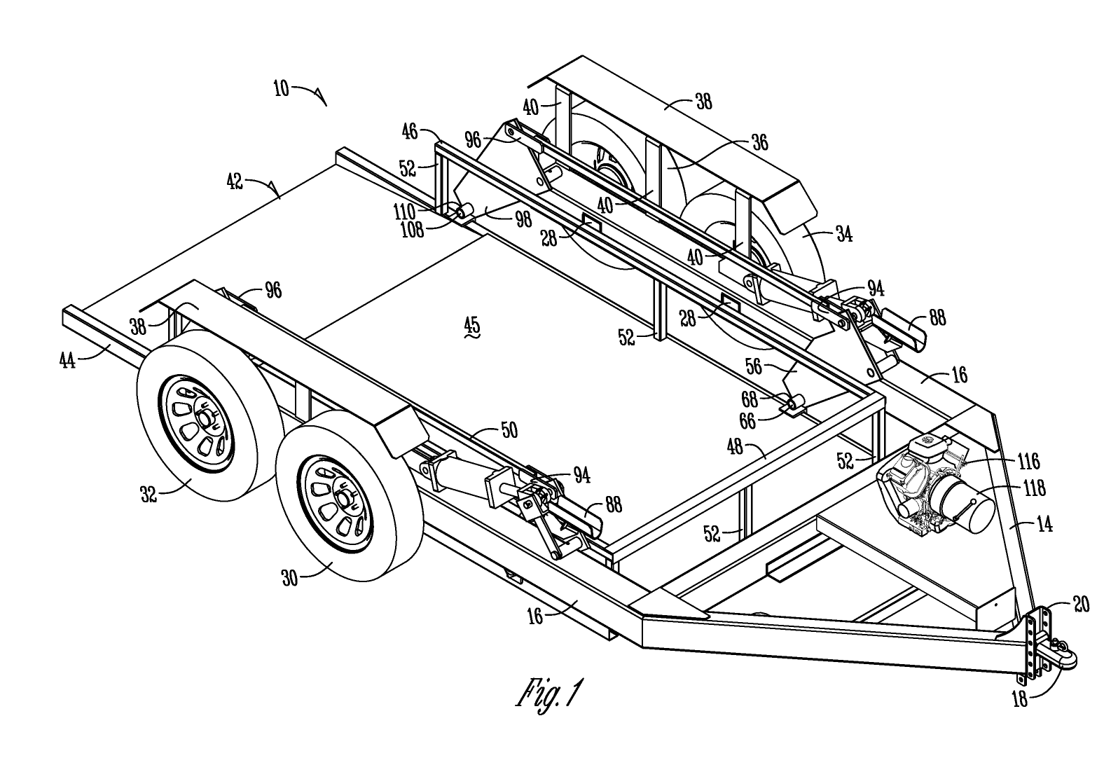

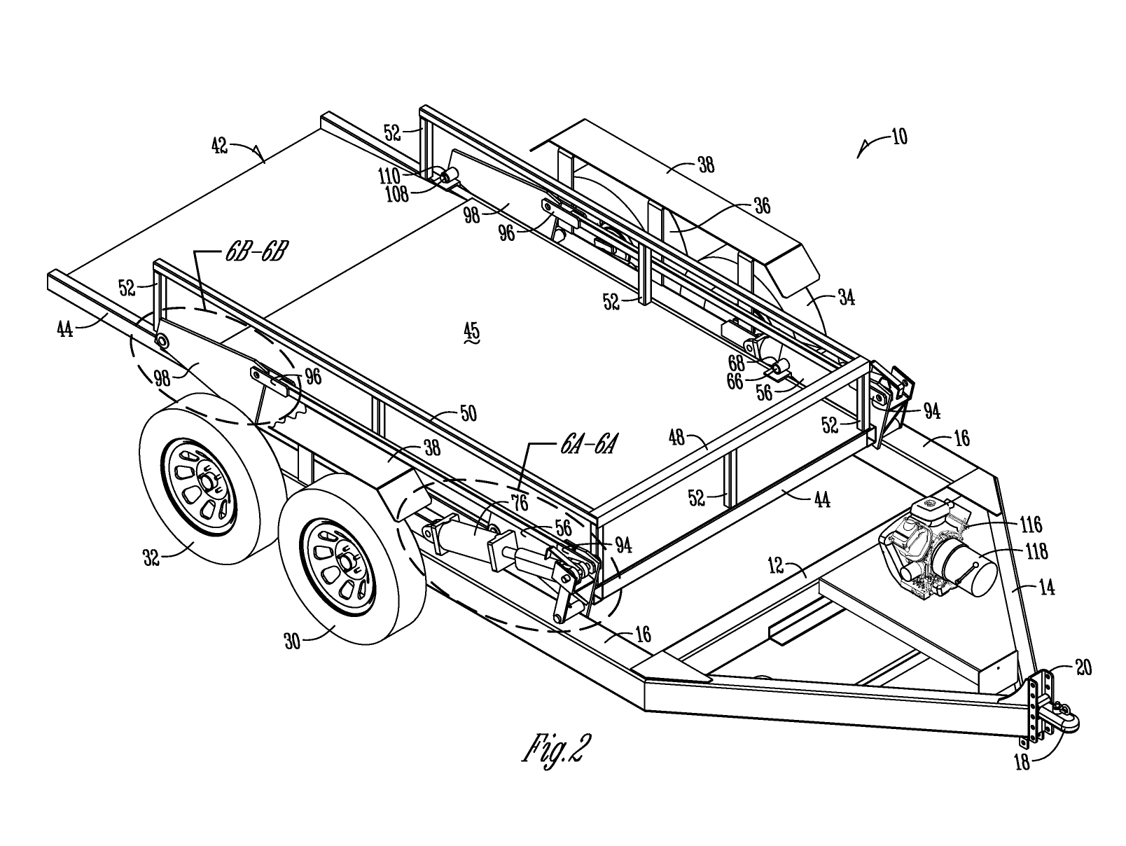

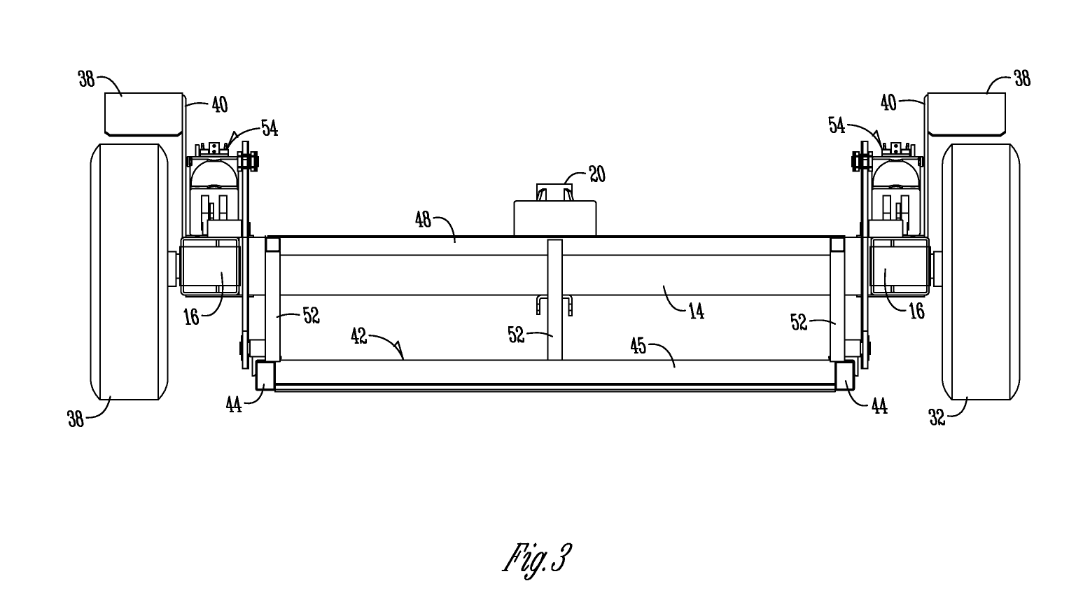

### DETAILED DESCRIPTION OF THE PREFERRED EMBODIMENTS

Referring to the drawings, wherein like numerals represent like parts throughout the several views, there is generally disclosed at 10 a trailer. The trailer 10 includes a frame 12 having a tongue 14 to which a pair of longitudinally extending frame members 16 are attached. The longitudinally extending frame member 16 and tongue 14 may be constructed of steel square tubing, or tubing of another type, shape or geometry. Operatively fixed to tongue 14 by a hitch mount 20 is a hitch 18. The hitch mount 20 is attached to tongue 14 in a generally upright and vertical fashion, and hitch 18 is vertically adjustable within the hitch mount 20 to accommodate hitches of varying height. For example, the hitch mount 20 may include a pair of upstanding rails having holes aligned horizontally there through whereby a pin and cotter pin arrangement may be used to secure the hitch 18 to the hitch mount 20 as shown. Operatively attached to the frame 12 at longitudinally extending frame members 16 are a plurality of axles 22-28. The axles are preferably a stub axle that extends at least partially through the longitudinally extending frame member 16 and terminates approximately adjacent the inside surface of the frame member. Axles 22-28 do not extend across the width of the trailer but terminate at or near the interior surface of the longitudinally extending frame member 16 as shown and described. To support the weight of the frame and the cargo carried by the trailer 10 it is preferred that axles 22-28 be a rubber ride type axle, such as those provided by Dexter Axle Corp. or Axis Products, Inc., both in Elkhart, Ind. Operably attached to each axle 22-28 is a wheel 30-36 which support the frame 12 of trailer 10 in an elevated position above the ground. In one aspect of the invention, a fender 38 is attached to each longitudinally extending frame member 16 and positioned over top of wheels 30-36. Fenders 38 are affixed to longitudinally extending frame member 16 by fender support arms 40.

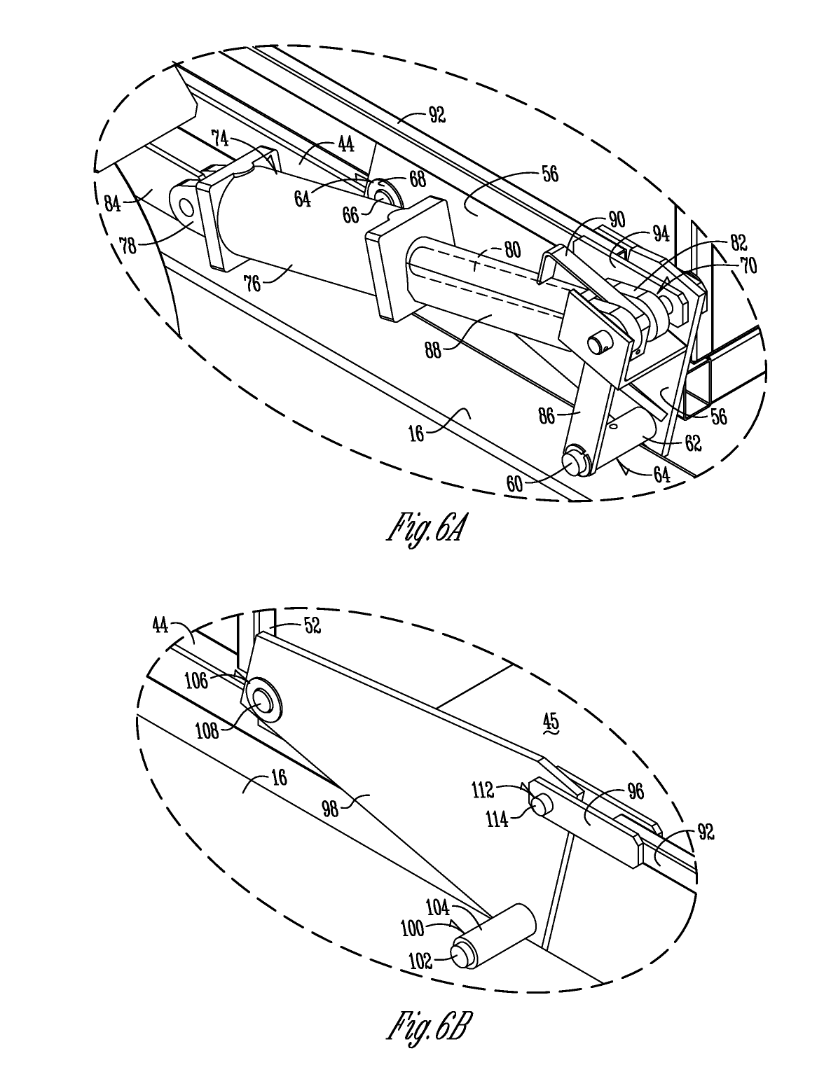

Operably attached to the frame 12 of trailer 10 is a bed 42 supported by a bed frame 44. The bed frame 44 supports a floor 45 for supporting cargo. Bed railing 46-50 is affixed to the bed frame 44 and oriented in a generally upright or vertical fashion relative to the frame to enclose and provide attachment points for the cargo supported by the bed 42. Bed railings 46-50 are affixed to the bed frame 44 by railing supports 52. The bed 42 is positioned between the longitudinally extending frame member 16 with the front end of the bed 42 being adjacent a forward portion of the frame 12 of trailer 10. As best illustrated in the figures, and particularly FIGS. 4, 6A and 6B, the bed 42 is operably attached to the frame 12 of the trailer 10 by a bed lifting and lowering assembly 54. The bed lifting and lowering assembly 54 includes a pivot plate 56 having a first connector 58 pivotally attached to a longitudinally extending frame member 16, a second connector 64 pivotally attached to bed frame 44 and a third connector 70. Means for actuating pivot plate 56, such as a linear extensible actuator 74 is attached to the frame 16 and plate 56. For example, a hydraulic cylinder having a first end may be pivotally attached to a longitudinally extending frame member 16 and its second opposite end pivotally attached to the third connector 70. Means for actuating pivot plate 56 include hydraulic, pneumatic, electric, or any like means. In one aspect of the invention the first connector 58 includes a pivot pin 60 rigidly attached to the pivot plate 56. The pivot pin 60 is received within a sleeve 62 rigidly attached to a longitudinally extending frame member 16. Similarly, the second connector 64 includes a pivot pin 66 rigidly attached to the pivot plate 56. The pivot pin 66 is received within a sleeve 68 rigidly attached to bed frame 44. Likewise, the third connector 70 includes a pivot pin 72 received through the pivot plate 56. The pivot pin 72 also is received through holes in a clevis 82 attached to cylinder rod 80 of the linear extensible actuator 74. The pivot pin 72 also extends through an end bracket 86, wherein the opposite end of the end bracket 86 (opposite the end with the pivot pin) is rigidly attached to the pivot pin 60 of the first connector 58.

The linear extensible actuator 74 includes a barrel 76 with a first end comprising a pin eye 78 pivotally attached to mounting bracket 84. Mounting bracket 84 is affixed to a longitudinally extending frame member 16. A cylinder rod 80 is actuated in and out of the barrel 76. The cylinder rod 80 terminates in a clevis 82 which is a U-shaped fixture having holes passing through each of the legs of the U-shaped member. The pivot pin 72 of the third connector 70 is received through the holes in the clevis 82. The pivot pin 72 is also received through a hole in the pivot plate 56 and an end bracket 86. Also secured to the third connector 70 by pivot pin 72 is a piston lockout 88. The piston lockout 88 is in the form of a U-shaped bracket and is hingeably attached to rotate about pivot pin 72 by hinge 90. A U-shaped bracket 94 having opposing holes in the legs is also attached to the third connector 70 by way of the pivot pin 72 passing through the holes of the U-shaped bracket 94. Thus, the U-shaped bracket 94 is pivotally attached to the third connector 70. Attached to the U-shaped bracket 94 is a connecting arm 92 that extends from the front of the bed 42 to the rear of the bed 42 and is generally parallel to the longitudinally extending frame member 16 and bed frame 44. Opposite the U-shaped bracket 94 on connecting arm 92 is another U-shaped bracket 96. The U-shaped bracket 96 is identical to the other U-shaped bracket 94 and includes opposing holes extending through the leg portions of the bracket. The U-shaped bracket 96 is pivotally attached to pivot plate 98 by third connector 112. In a preferred aspect of the invention, the third connector 112 includes a pivot pin 114 extending through pivot plate 98 and U-shaped bracket 96 so as to pivotally secure and attach the U-shaped bracket 96 to pivot plate 98. Pivot plate 98 includes identical features to pivot plate 56. Pivot plate 98 includes a first connector 100 pivotally attached to a longitudinally extending frame member 16. In a preferred aspect of the invention, the first connector 100 includes a pivot pin 102 rigidly attached to the pivot plate 98. The pivot pin 102 is received within a sleeve 104 rigidly attached to a longitudinally extending frame member 16. The second connector 106 is pivotally attached to the bed frame 44 and in a preferred aspect of the invention includes a pivot pin 108 rigidly attached to the pivot plate 98. The pivot pin 114 is received within a sleeve 110 rigidly attached to the bed frame 44. As previously discussed, the third connector 112 includes a pivot pin 114. The pivot pin 114 may be rigidly attached to pivot plate 102 and received through holes in U-shaped bracket 96 or received through holes in U-shaped bracket 96 and a hole in the pivot plate 98 to thereby allow U-shaped bracket 96 to pivot about pivot plate 98 when connecting arm 92 is actuated forward and rearward.

In one aspect of the invention, a gas powered motor 116 is operably attached to frame 12. The gas powered motor 116 is operatively connected to a hydraulic pump 118 for providing hydraulic fluid to and for operating the linear extensible actuator 74. In another aspect of the present invention, an electric motor 116 is attached to the frame 12 of trailer 10. Electricity from a battery powers the electric motor 116 which in turn is operably connected to a hydraulic pump 118 for providing hydraulic fluid at a sufficient pressure for operating the linear extensible actuator 74.

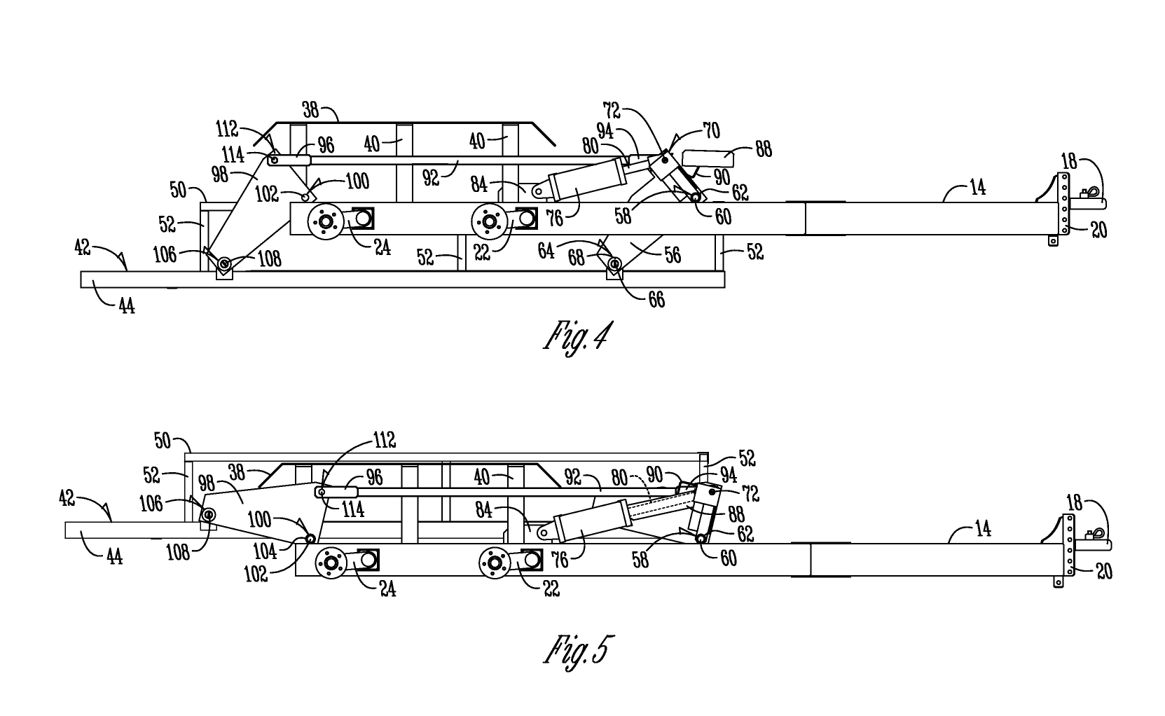

Operation of the trailer 10 is illustrated and shown by the figures and particularly FIGS. 4, 5, 6A and 6B. In FIG. 4, the bed 42 is shown in a loading position. In the loading position, the bed 42 is positioned adjacent the ground. In FIG. 5 the bed 42 is shown in the trailing position. In the trailing position the bed 42 is generally level with and on the same plane as the trailer frame 12.

The following describes movement of the bed 42 from the trailing to the loading position and visa versa. Movement of the bed 42 relative to the frame 12 of trailer 10 is provided by operably attaching bed frame 44 of bed 42 to the longitudinally extending frame member 16 of frame 12. Generally, the pivot plate 56 and pivot plate 98 include a first connector 58 and 100 pivotally attached to a longitudinally extending frame member 16. Pivot plate 56 and 98 also include a second connector 64 pivotally attached to bed frame 44. The third connector 70 and 112 attached to pivot plates 56 and 98 respectively are linked together by connecting arm 92. The distance of separation between the first and second connectors on both pivot plates 56 and 98 is a sufficient distance so as to allow the bed 42 to descend a sufficient enough distance so as to lie adjacent the ground in the loading position. Depending upon the height of the frame 12 the appropriate spacing of the first and second connectors on both pivot plates may be calculated so that the bed 42 may be lowered a sufficient distance so as to position the bed 42 approximate the ground. Similarly, the spacing between the first and second connector on the pivot plate 56 and 98 may also be optimized so that the bed 42 moves from the loading to trailing position and visa versa with minimal extension and retraction of cylinder rod 80. Furthermore, the spacing of the first connector, second connector and third connector on the pivot plate 56 and pivot plate 98 may also be optimized so as to allow the linear extensible actuator 74 to have a mechanical advantage in moving the bed 42 between the trailing and loading positions or visa versa. In the trailing position, the cylinder rod 80 is in the extended position and locked out from movement by rotating and positioning the piston lockout 88 over the cylinder rod between the end of the barrel 76 and clevis 82 of the linear extensible actuator 74. Also, with the piston lockout 88 positioned over top the cylinder rod 80 the clevis 82 is prevented from retracting toward the barrel 76 of linear extensible actuator 74. With the piston lockout 88 positioned over top of the cylinder rod 80, the bed 42 is prevented from any movement relative to the frame 12 of trailer 10, and is positioned for trailing cargo. To move the bed 42 from the trailing position to the loading position, the piston lockout 88 is rotated out of obstruction between the barrel 76 and clevis 82 of the linear extensible actuator 74. Controls (not shown) operably attached to the motor 116 driving hydraulic pump 118 are operated to provide hydraulic fluid to the linear extensible actuator 74 to allow cylinder rod 80 to retract into the barrel 76. Retraction of the cylinder rod 80 allows the bed 42 to descend toward the ground as pivot plates 56 and 98 rotate about first connectors 58 and 100. As the bed 42 descends toward the ground, second connector 64 and second connector 106 descend from the trailing position to the loading position, the descent being radial movement about the first connector 58 and 100. The radius of the radial movement being the distance between the first connector 58 and second connector 64 on pivot plate 56 and the distance between the first connector 100 and second connector 106 on pivot plate 98. To ensure that the bed 42 is fully engaging the ground, the cylinder rod 80 may be retracted to the point where the frame 12 of trailer 10 is lifted up off of the ground by the retraction of cylinder rod 80 to firmly plant or secure the bed 42 against the ground while loading the trailer 10 with cargo. With the connecting arm 92 pivotally attaching pivot plate 56 to pivot plate 98, any movement imparted to pivot plate 56 by linear extensible actuator 74 is also transmitted to pivot plate 98 via connecting arm 92. Thus, actuation of the linear extensible actuator 74 departs like motion to both pivot plates 56 and 98.

The bed 42 is moved from the loading position to the trailing position by operating the motor 116 connected to hydraulic pump 116. Hydraulic fluid from the hydraulic pump 118 causes the cylinder rod 80 within the linear extensible actuator 74 to extend out of the barrel 76. Extension of the cylinder rod 80 imparts a clockwise rotation to both pivot plate 56 and 98 about first connector 58 and 100 respectively. As the bed 42 ascends toward the trailing position, second connector 64 and 106 on pivot plates 56 and 98 pivot so as to maintain the bed 42 in a parallel orientation relative to the frame 12 of trailer 10. The cylinder rod 80 is extended until the bed 42 is generally parallel with or on the same plane as the frame 12 of trailer 10. This is accomplished by rotating both pivot plates 56 and 98 in a clockwise manner. The second connector 64 and 106 are rotated clockwise relative to first connectors 58 and 100 until generally on the same plate with first connectors 58 and 100. Thus, in the trailing position, the second connector 64 and 106 are generally in the same plane as the first connectors 58 and 100. In the loading position the second connector 64 and 106 lie in a plane generally parallel to the first connectors 58 and 100. Likewise, the trailing position, the third connectors 70 and 112 are generally in the same vertical plane as the first connectors 58 and 100. The present invention contemplates various pivot plate geometries or shapes yielding various desirable movement of the bed 42 relative to the frame 12. For example, the pivot plate 56 and 98 could be designed in an oval or oblong shape or geometry, or even a cam shaped geometry so as to provide the linear extensible actuator 74 with mechanical advantage over the pivot plates 56 and 98 when moving the bed 42 from the loading position to the trailing position. Furthermore, the pivot plates 56 and 98 could be shaped so as to quicken the descent and ascent of the bed 42 relative to the frame 12 while maintaining the same cylinder rod extension and retraction rates.

These and/or other embodiments and aspects of the invention are contemplated as evidenced by the figures and the written description.

The above specification, examples and data provide a complete description of the manufacture and use of the composition of the invention. Since many embodiments of the invention can be made without departing from the spirit and scope of the invention, the invention resides and the claims hereinafter are appended.

What is claimed is:

1. A trailer comprising:
a frame having a tongue connected to a pair of longitudinally extending frame members;
a bed operatively attached to the pair of longitudinally extending frame members and actuated between trailing and loading positions by:
a. a pivot plate having a first connector pivotally attached to a longitudinally extending frame member, a second connector pivotally attached to the bed and a third connector; and
b. a linear extensible actuator having a first end pivotally attached to the longitudinally extending frame member and a second end pivotally attached to the third connector.

2. The trailer of claim 1 wherein the first connector comprises a pivot pin rigidly attached to the pivot plate and received within a sleeve rigidly attached to the longitudinally extending frame member.

3. The trailer of claim 1 wherein the second connector comprises a pivot pin rigidly attached to the pivot plate and received within a sleeve rigidly attached to the bed.

4. The trailer of claim 1 wherein the third connector comprises a pivot pin received through the pivot plate, a clevis attached to a cylinder rod of the linear extensible actuator, and an end bracket rigidly attached to the first connector.

5. The trailer of claim 4 wherein the third connector further comprises a piston lockout member pivotally attached to the pivot pin and moveable between locked and unlocked positions.

6. The trailer of claim 1 further comprising a second pivot plate having a first connector pivotally attached to the longitudinally extending frame member, a second connector pivotally attached to the bed and a third connector.

7. The trailer of claim 6 further comprising a connecting arm having opposing ends with a U-shaped bracket, one bracket pivotally attached to the third connector on the pivot plate and the other bracket pivotally attached to the third connector on the second pivot plate.

8. The trailer of claim 1 further comprises a motor operably connected to a hydraulic pump, the pump connected in fluid communication to the linear extensible actuator to move the bed between trailing and loading positions.

9. The trailer of claim 1 wherein the bed rests on the ground and the pair of longitudinally extending frame members remain elevated above the ground in the loading position.

10. A trailer comprising:
a generally U-shaped frame having a pair of longitudinally extending frame members;
a bed operatively attached to the pair of longitudinally extending frame members and actuated between trailing and loading positions by:
a. a first pivot plate having a first connector pivotally attached to a longitudinally extending frame member, a second connector pivotally attached to the bed and a third connector;
b. a second pivot plate having a first connector pivotally attached to the longitudinally extending frame member, a second connector pivotally attached to the bed and a third connector operably attached to the third connector on the first pivot plate by a connecting arm; and
c. means for rotating the first pivot plate for moving the bed between trailing and loading positions.

11. The trailer of claim 10 wherein the means for rotating the first pivot plate comprises a linear extensible actuator having a first end pivotally attached to a longitudinally extending frame member and a second end pivotally attached to the third connector on the first pivot plate.

12. The trailer of claim 10 wherein the first connector on the first and second pivot plate comprises a pivot pin rigidly attached to the pivot plate and received within a sleeve rigidly attached to the longitudinally extending frame member.

13. The trailer of claim 10 wherein the second connector on the first and scond pivot plate comprises a pivot pin rigidly attached to the pivot plate and received within a sleeve rigidly attached to the bed.

14. The trailer of claim 10 wherein the third connector on the first pivot plate comprises a pivot pin received through the pivot plate, a driven member of the rotating means, and an end bracket rigidly attached to the first connector.

15. A trailer comprising:
a frame having a pair of longitudinally extending frame members;
a bed operatively attached to the pair of longitudinally extending frame members and actuated between trailing and loading positions by:
a. a pivot plate pivotally attached to a longitudinally extending frame member and to the bed; and
b. means for imparting rotation to the pivot plate for moving the bed between trailing and loading positions.

16. The trailer of claim 15 further comprises a second pivot plate pivotally attached to the longitudinally extending frame member and the bed.

17. The trailer of claim 16 further comprises a connecting arm pivotally attached to both the pivot plate and the second pivot plate.

18. A method for raising and lowering the bed of a trailer between trailing and loading positions, the method comprising:
providing a trailer having a frame with a pair of longitudinally extending frame members and a bed operatively attached to the pair of longitudinally extending frame members and actuated between trailing and loading positions by:
a. connecting a pivot plate to a longitudinally extending frame member, the bed and means for imparting rotation to the pivot plate; and
b. rotating the pivot plate about a fixed pivot point on the longitudinally extending frame member for moving the bed up and down.

19. The method of claim 18 further comprising connecting a second pivot plate to the longitudinally extending frame member and the bed.

20. The method of claim 19 further comprising attaching a connecting arm between the two pivot plates for imparting rotation to the second pivot plate by rotating the pivot plate.
